(19) United States
(12) Patent Application Publication
(10) Pub. No.: US 2013/0096237 A1
(43) Pub. Date: Apr. 18, 2013

(54) COMPOSITE MATERIAL MADE OF A MATERIAL CONTAINING CELLULOSE WITH PMMA AS A PLASTIC MATRIX USING DIFFERENT COUPLING COMPONENTS

(71) Applicants: Carlo Schuetz, Messel (DE); Christian Roth, Lautertal (DE); Ruediger Carloff, Darmstadt (DE); Klaus Schultes, Wiesbaden (DE); Victor Khrenov, Frankfurt (DE); Eric Reinheimer, Gross-Zimmern (DE)

(72) Inventors: Carlo Schuetz, Messel (DE); Christian Roth, Lautertal (DE); Ruediger Carloff, Darmstadt (DE); Klaus Schultes, Wiesbaden (DE); Victor Khrenov, Frankfurt (DE); Eric Reinheimer, Gross-Zimmern (DE)

(73) Assignee: Evonik Roehm GmbH, Darmstadt (DE)

(21) Appl. No.: 13/703,746

(22) PCT Filed: Jun. 1, 2011
(86) PCT No.: PCT/EP2011/059006

§ 371 Date: Dec. 12, 2012

(30) Foreign Application Priority Data
Jul. 5, 2010 (DE) 102010030926.5

(51) Int. Cl. C08L 33/12

(52) U.S. Cl. CPC C08L 33/12
USPC 524/13

(57) ABSTRACT

The invention relates to novel composite materials with improved mechanical properties and improved weathering resistance, said composite materials being made of at least one material containing cellulose, preferably wood, and at least one plastic, and to a method for producing said composite materials and for using same.

The present invention relates to novel composite materials made of at least one cellulose-containing material, preferably wood, and of at least one plastic, with improved mechanical properties and improved weathering resistance, a process for producing these, and their use.

Composite materials made of at least one cellulose-containing material and of at least one plastic are currently in particularly produced industrially in the form of wood-plastic composite materials, known as WPCs or wood plastic composites. For the purposes of the invention described hereinafter, the expressions “wood-plastic-composite material(s)” and “WPC(s)” are used synonymously.

Historically, materials generally used for construction and furniture were solid timber and traditional timber-based materials. WPC materials have expanded these traditional application sectors to cover significant additional possible uses, by virtue of improved shaping methods.

WPC materials involve bonding of wood particles (such as wood fragments, sawdust, wood fibers, or wood flour) to a plastics matrix. Thermoplastics generally serve as plastics matrix.

When WPCs were originally developed in North America, woods were used mainly as inexpensive filler. The costs for the wood particles are a fraction of those for the plastics used as an alternative thereto and the wood content therefore reduces materials costs in the product. Wood has a higher modulus of elasticity than the plastics used, and an optimized wood-plastic combination therefore gives better mechanical properties than the plastic alone.

Three plastics are predominant worldwide in almost all WPC materials produced commercially. In America it is primarily polyethylene (PE) that is used, but in Europe polypropylene (PP) is mainly used. In Asia, polyvinyl chloride (PVC) is very often used as WPC plastic. All three plastics are mass-produced and can therefore be obtained at relatively low cost. This commercial aspect is one of the causes for the concentration of WPC research hitherto almost exclusively on the thermoplastics mentioned.

On the other hand, there continues to be a requirement to provide longlasting coupling of natural fibers (e.g. cellulose) to polymers. In the case of the plastics mentioned, PE, PP, and PVC, decades of development have adequately solved the problem of coupling to wood fibers, by using adhesion promoters.

Current further development of WPC materials is concerned not only with optimizing processing technology but also to a very great extent with improving product properties or with properties tailored for particular intended purposes.

WPC materials are currently used mainly outdoors. Garden decking provides a major application for WPC. Here, WPC materials primarily compete with high-grade timbers from subtropical regions. WPC materials in construction applications are expected not only to provide a strong material but also to have very high durability, or at least durability comparable to that of robust natural timbers.

The starting materials used in WPC materials generally cause these to undergo alteration due to weathering effects when they are used outdoors, unless they are protected by a surface finish. The degree of aging depends firstly on the robustness of the wood fibers used, and secondly on the long-term performance of the plastic used.

It is well-known that plastics have very wide ranges of properties. This applies not only to thermal properties but also to mechanical and long-term properties. Against the background of the development of durable WPC materials for the outdoor sector, there therefore continues to be a requirement for composite materials with better weathering resistance than WPCs based on polyolefins.

WPC materials are often produced by way of injection-molding processes or extrusion processes, and the production process therefore uses plastification at the melt temperature of the plastics component. Polymerization processes using solution chemistry with wood particles are also used, but less often.

Polymethyl methacrylate, abbreviated to PMMA, is known for extremely good weathering resistance and high mechanical strength values. Its property profile is therefore very suitable for construction applications. However, it has not hitherto been possible to use this material for WPC applications because processing temperatures required during the extrusion process were too high and there was resultant damage to the wood particles. The problem of coupling the PMMA to the wood particles has moreover not hitherto been satisfactorily solved.

Starting from the prior art described above, the object therefore consisted in providing composite materials made of at least one cellulose-containing material, preferably wood, and of at least one plastic, with improved weathering resistance and improved mechanical properties, and also a process for producing these.

Another object consisted in providing weathering-resistant WPC materials without additional surface finishing.

Further objects not explicitly mentioned are apparent from the entire context of the description, examples, and claims hereinafter.

The present invention is based on the concept of producing novel composite materials by using poly(alkyl) (meth)acrylate and a thermoplastic with excellent weathering resistance. The strengths of this plastic have successfully been combined with the advantages of the cellulose-containing components to give tailored composite materials.

The main task here was to achieve sufficiently good adhesion, linkage, or coupling of the cellulose-containing material, in particular natural fibers or wood fibers, to the polymer, and to lower the processing temperature to an extent that permits avoidance of carbonization of the wood particles. This was achieved by using a specific poly(alkyl) (meth)acrylate together with a cellulose-compatible adhesion promoter and a lubricant.

The present invention therefore provides a composite material made of at least one cellulose-containing component, preferably wood, and at least one plastic, characterized in that the plastic comprises
a) a poly(alkyl) (meth)acrylate matrix material with
   a1) a MVR melt index [230° C., 3.8 kg] in the range from 0.5 to 30 ml/10 min, particularly preferably from 1 to 20 ml/10 min, and very particularly preferably in the range from 1 to 10 ml/10 min, and
b) a cellulose-compatible adhesion promoter, and
   in that the composite material comprises a lubricant.

The present invention further provides a process in which at least one plastic described in more detail above is mixed with at least one cellulose-containing material, with a lubricant, and optionally with further components, and is then processed to give a composite material.

The invention likewise provides the use of the composite material of the invention, in particular as material in sectors with relatively high exposure to moisture, in particular in the outdoor sector, for example as flooring, e.g. garden decking, etc., as construction materials, for example as framing timber, boards, beams, staircases and staircase steps, posts, formwork panels, garden sheds, climbing frames, play equipment, sandpits, carports, gazebos, door frames, doors, windowsills, etc., as walling elements, as wall cladding, sound-deadening elements, balustrades, as ceiling cladding, as roof covering, in shipbuilding, or for the construction of harbor facilities, e.g. landing stages, fenders, ship decks, etc., as maintenance-free furniture material in the indoor and outdoor sector, for example chairs, sunbeds, shelving, bar tops, garden seats, kitchen furniture, worktops, bathroom furniture, etc., as containers or edging, for example lawn edging, flower-bed edging, log-roll edging, flower pots, plant troughs, etc., as play blocks, and as decorative materials for automobile interiors, and in the external shell of automobiles, and also as mounted components for mobile homes.

The composite material of the invention is extremely suitable for practical use outdoors since it has low water absorption, high dimensional stability due to low swelling behavior, and high mechanical strength.

The possibility of processing at temperatures below or equal to 225° C., preferably below or equal to 220° C., permits avoidance of damage to the cellulose-containing material, in particular when wood is used, and lowers energy costs.

In particular, when a plastic of the invention is used together with a lubricant it is possible to produce a composite material which, astoundingly, can be extruded successfully at about 205° C. with 70% by weight wood content. This method can moreover give WPCs with up to 80% by weight wood content.

The performance of the extrudates of the invention in the presence of moisture is the same as, or better than, that of WPCs based on polyolefin. Additional factors in comparison with polyolefins are the better mechanical properties of the plastics matrix of the invention and its excellent weathering resistance.

Trials have shown that when the water absorption of the WPCs of the invention is compared to that of WPCs made of PMMA alone it can be reduced from about 30% by weight to less than 6% by weight, thus being within the appropriate range of requirements for WPC products in the outdoor sector.

A high-quality WPC based on poly(alkyl) (meth)acrylate has therefore been produced.

The present invention is described in detail hereinafter.

The quality of WPC materials depends greatly on compliance with various parameters: the inventors have discovered that the flow properties of the polymer are just as important as compliance with particular upper temperature limits where wood particles begin to suffer damage. It has been found that in the production of WPC materials this temperature should be below 225° C., preferably below 220° C., in order to provide substantial exclusion of carbonization of the wood particles. At said temperature the polymer should also be molten and have adequate flowability. This fact alone has hitherto been the reason for avoiding use of PMMA, since standard PMMA does not exhibit viscoelastic flow below 230° C.

Another decisive factor for the use of WPC materials is that product properties which affect performance reach minimum values or, respectively, do not exceed upper limits. Examples of these are weight increase caused by water, swelling in wet conditions, and strength values, e.g. flexural strength and breaking strength.

Materials such as wood fibers that have cellulose as main constituent are highly polar and hydrophilic. Moisture absorption, which can extend to great depths within the material, is mainly the result of the hydrophilic nature of the cellulose-containing material.

The present invention successfully uses a cellulose-compatible adhesion promoter together with a specific poly(alkyl) (meth)acrylate matrix material and a lubricant to achieve very good to complete “surrounding” or “sheathing” of wood particles by the polymer. This significantly reduces water absorption.

For the purposes of the present invention, poly(alkyl) (meth)acrylate matrix material is a matrix material which comprises exclusively poly(alkyl) (meth)acrylate as polymer component, or else a matrix material which comprises a blend made of various poly(alkyl) (meth)acrylates or of poly(alkyl) (meth)acrylate(s) and of other polymers, or else a matrix material which involves a copolymer of at least one poly(alkyl) (meth)acrylate and of other comonomers, preferably styrene, α-methylstyrene, (meth)acrylic acid and/or (alkyl)acrylates, glutaric anhydrides, (alkyl) (meth)acrylamines, (alkyl) (meth)acrylimides, N-vinylpyrrolidone, vinyl acetate, ethylene or propylene.

The flow behavior of the poly(alkyl) (meth)acrylate matrix material has been found to be an important criterion. The MVR melt index [230° C., 3.8 kg] of the poly(alkyl) (meth)acrylate used as matrix material of the invention is therefore in the range from 0.5 to 30 ml/10 min, preferably from 1 to 20 ml/10 min, and particularly preferably in the range from 1 to 10 ml/10 min.

Experiments with various grades of poly(alkyl) (meth)acrylate have shown that if the molecular weight of poly(alkyl) (meth)acrylate melts is too high it is very difficult to achieve mixing with, for example, wood particles, since onset of damage to the wood particles was found to occur when the necessary temperature increase was implemented. If the molecular weight of the poly(alkyl) (meth)acrylate is too low, problems can arise with “floating” of the wood fibers in the plastification equipment, and there can therefore be difficulties with the mixing of the components.

The definition of “alkyl” in the poly(alkyl) (meth)acrylate matrix material can be the same as the definition given above for the copolymer. It is particularly preferable to use polymethyl (meth)acrylate, polyethyl (meth)acrylate, or polybutyl (meth) acrylate.

For the purposes of the present invention, the term “(meth)acrylate” means very generally not only methacrylates but also acrylates, and also mixtures of the two.

The plastic in the present invention comprises not only the poly(alkyl) (meth)acrylate matrix material but also at least one cellulose-compatible adhesion promoter. A “cellulose-compatible adhesion promoter” means an adhesion promoter which comprises functional groups which can form hydrogen bonds, ionic bonds, or chemical bonds with the OH groups of the cellulose.

In a first preferred embodiment of the present invention, the adhesion promoter is added as separate component alongside the matrix material (component a) to the formulation for the composite material. This means that although the matrix material can be a copolymer, the adhesion promoter in this embodiment does not form a copolymer with the matrix polymer and is not a constituent of a matrix copolymer. The adhesion promoter preferably used here preferably involves a copolymer comprising one or more monomers selected from the group consisting of cyclic carboxylic anhydride derivatives, e.g. glutaric anhydride, (meth)acrylic acid derivatives, e.g. methacrylic acid or acrylic acid, amino monomers, imide monomers, and monomers comprising epoxy groups, preferably (alkyl) (meth)acrylamines, (alkyl) (meth)acrylimides, N-vinylpyrrolidone. It is moreover possible that one or more monomers selected from the group consisting of styrene, α-methylstyrene, α-styrene, acrylates, methacrylates, vinyl acetate, ethylene, and propylene are present.

The copolymers of the adhesion promoter can be used with random distribution of the monomer units or else as graft copolymer. Cyclic carboxylic anhydride derivatives used are preferably those having a 5-, 6-, or 7-membered ring, particularly preferably maleic anhydride and glutaric anhydride.

“Alkyl” in the adhesion-promoter copolymer means a branched or unbranched, cyclic or linear alkyl moiety which has from 1 to 20, preferably from 1 to 8, particularly preferably from 1 to 4, carbon atoms and which can have substitution by functional groups, or can comprise heteroatoms, such as 0, S, or N. It is preferable that a methyl, ethyl, butyl, or cyclohexyl moiety is involved.

The adhesion promoter used in the invention preferably involves a low-molecular-weight copolymer, particularly preferably a styrene-maleic anhydride copolymer, very particularly preferably a polymer available commercially with trademark XIRAN® SMA from Polyscope Polymers B. V., based in the Netherlands.

The MVR melt index [230° C., 3.8 kg] of the adhesion-promoter copolymer is preferably in the range from 1 to 30 ml/10 min, particularly preferably from 2 to 20 ml/10 min, and very particularly preferably in the range from 3 to 15 ml/10 min.

The proportion of the adhesion promoter, based on the total weight of the composite material of the invention, depends on the concentration, within the adhesion promoter, of the functional groups capable of bridging to the cellulose. The proportion of the adhesion promoter can vary from 0.5 to 70% by weight, preferably from 1% by weight to 50% by weight, particularly preferably from 1% by weight to 40% by weight, very particularly preferably from 2% by weight to 30% by weight, specifically preferably in the range from 3% by weight to 25% by weight and very specifically preferably in the range from 3% by weight to 15% by weight. In one very particularly preferred embodiment, a styrene-maleic anhydride copolymer is used and is namely Xiran® SZ 22065—having about 20-22% by weight of effective maleic anhydride groups.

This first preferred embodiment permits maximum flexibility in the production and composition of the composite material.

In a second preferred embodiment of the present invention, the adhesion promoter (component b) and the matrix polymer (component a) are “fused” to one another, i.e. a copolymer is formed from the adhesion promoter and the matrix polymer, so that the “adhesion-promoter-modified” matrix polymer can be used directly to produce the composite material. In this case there is no need to add an adhesion promoter as separate further component, although it is certainly possible to do so.

In this embodiment it is preferable to use a copolymer of poly(alkyl) (meth)acrylate and of the adhesion promoter, preferably selected from the group consisting of (meth)acrylic acid monomer, cyclic carboxylic anhydride derivatives, glutaric anhydride, (meth)acrylic acid derivatives, preferably (meth)acrylic acid, aminomonomers, imide monomers, and monomers comprising epoxy groups, with styrene, a-styrene, acrylates, and/or methacrylates, an example being Altuglas® HT121.

The MVR [230° C., 3.8 kg] of the adhesion-promoter copolymer, preferably of poly(alkyl) (meth)acrylate and (meth)acrylic acid, is preferably in the range from 0.5 to 30 ml/10 min, particularly preferably from 1 to 20 ml/10 min, and very particularly preferably in the range from 1 to 10 ml/10 min, and this copolymer therefore ensures that the processing temperature is sufficiently low and that it is sufficiently easy to incorporate the cellulose component.

This second preferred embodiment has the particular advantage that components a) and b) do not have to be added separately from one another during the production of the composite material, and therefore that the cost of producing the composite material is lower.

In one particularly preferred embodiment of the present invention, which also comprises the two preferred embodiments described above, the adhesion promoter comprises a cyclic carboxylic anhydride derivative, the proportion of which is in the range from 0.1 to 5% by weight and particularly preferably in the range from 0.4 to 3% by weight, based on the total weight of the composite material of the invention.

The composite material of the invention also comprises, alongside the adhesion promoter and the poly(alkyl) (meth)acrylate matrix polymer, a cellulose-containing component, in particular wood particles. The proportion of the cellulose-containing component in the composite material greatly influences the properties of the product: on the one hand, flexibility and mechanical properties are improved, and an economic advantage is also achieved; on the other hand a high proportion leads to increased moisture absorption, and it is therefore difficult to achieve a very high proportion of cellulose-containing component. A proportion of wood filler that has been successfully achieved with the composite material of the invention is in particular up to 80% by weight, preferably from 40 to 80% by weight, particularly preferably from 50 to 80% by weight, and very particularly preferably from 60 to 75% by weight, based in each case on the total weight of the composite material.

Cellulose-containing component used in the invention preferably involves wood or paper or paperboard, or other cellulose-containing materials. The cellulose content of the cellulose-containing component is preferably at least 20% by weight, particularly preferably at least 30% by weight, very particularly preferably at least 40% by weight. It is particularly preferable to use wood. No particular restrictions apply in relation to the wood particles in the composite materials of the invention. By way of example, wood fragments, sawdust, wood fibers or wood flour can be used.

For the purposes of the present invention, it has been found to be advantageous for the composite material to comprise a lubricant. The lubricant is important for achieving good processability of the molding composition and low processing temperatures. Particular lubricants that can be used are polyolefins, polar ester waxes, polyethylene waxes, carboxylic acids and fatty acids, and also esters of these (e.g. stearates), or else long-chain fatty alcohols and fatty alcohol esters. The proportion of the lubricant based on the total mass of the composite material, is preferably from 0.1 to 5% by weight, particularly preferably from 0.1 to 4% by weight, very particularly preferably from 0.5 to 4% by weight, and specifically preferably from 1 to 3% by weight.

The composite materials of the invention can comprise other conventional auxiliaries and/or additives, e.g. dyes, light stabilizers, IR absorbers, antimicrobial ingredients, flame retardants, heat stabilizers, antioxidants, crosslinking polymers, additional fiber-reinforcing additives of organic or inorganic type, polysiloxanes, polysiloxane amines, and/or polysiloxane imines.

In a particularly preferred embodiment, the composite materials of the invention comprise, in the plastic, an impact modifier, the proportion of which is in particular from 0.1 to 15% by weight, preferably from 0.5 to 10% by weight, and very particularly preferably from 1 to 6% by weight, based in each case on the mass of the plastics components present in the composite material. It is possible to use any of the commercially available impact modifiers, in particular elastomer particles with an average particle diameter of from 10 to 300 nm (measured by way of example by the ultracentrifuge method). The elastomer particles preferably have a core with a soft elastomer phase and at least one hard phase bonded thereon.

Wood-plastics composite materials which have been found to be particularly advantageous comprise up to 80% by weight of wood particles, and also at least 15% by weight of poly(alkyl) (meth)acrylate, based in each case on the total weight of the composite material.

In a particularly preferred embodiment of the present invention, the composite material of the invention comprises the following components:
a) poly(alkyl) (meth)acrylate matrix polymer:
   from 1 to 59% by weight,
   preferably from 1 to 57.5% by weight
b) adhesion promoter:
   from 1 to 50% by weight
c) cellulose-containing component, preferably wood fibers:
   from 40 to 80% by weight
d) lubricant:
   from 0.1 to 5% by weight,
   preferably from 0.5 to 4% by weight,
   particularly preferably from 0.5 to 3% by weight
e) colorant from 0 to 5% by weight
f) light stabilizers
   from 0 to 0.5% by weight,
   preferably from 0.01 to 0.2% by weight,
      where components a) and b) together make up from 9.5% by weight to 59.9% by weight of the total weight of the six abovementioned components, and the entirety of the contents of the six abovementioned components gives 100% by weight. In this case, 100% by weight refers to the total weight of the abovementioned components. This can be the same as the total weight of the composite material, but can also amount to less than 100% by weight of the composite material if the composite material also comprises components other than the abovementioned six. Components a) and b) can be combined as in the preferred embodiment above in the form of one component.

The composite material of the invention can be produced by mixing at least one cellulose-containing material with at least one plastic described above, one lubricant, and optionally one and/or one other of the abovementioned auxiliaries and/or additives, and processing to give a composite material. Said processing preferably uses extrusion or injection molding. It is preferable here to plasticize at a melt temperature below 230° C., particularly preferably below 225° C., very particularly preferably from 170 to 220° C., specifically preferably from 190 to 215° C., and very specifically preferably from 190 to 210° C.

The composite materials of the invention can be used in any of the applications known for WPC, in particular as material in sectors with relatively high exposure to moisture, specifically in the outdoor sector, for example as flooring, e.g. garden decking, etc., as construction materials, for example as framing timber, boards, beams, posts, formwork panels, garden sheds, climbing frames, play equipment, sandpits, carports, gazebos, door frames, doors, windowsills, etc., as walling elements, as wall cladding, sound-deadening elements, balustrades, as ceiling cladding, as roof covering, in shipbuilding, or for the construction of harbor facilities, e.g. landing stages, fenders, ship decks, etc., as maintenance-free furniture material in the indoor and outdoor sector, for example chairs, sunbeds, shelving, bar tops, garden seats, kitchen furniture, worktops, bathroom furniture, etc., as containers or edging, for example lawn edging, flower-bed edging, log-roll edging, flower pots, plant troughs, etc.

The sound-deadening effect of the components of the invention can derive from reflection of the sound or else from absorption. For the application as sound-deadening elements with sound-absorbing effect it is preferable to produce components which are made of the composite materials of the invention and the surface of which has structuring that achieves a sound-absorbing effect, whereas for reflection smooth surfaces of the components are also adequate. It is moreover particularly preferable to use the composite materials of the invention to produce panels having hollow chambers, or profiles, where these have appropriate apertures or bores which allow the sound waves to penetrate into the component. A significant sound-absorption effect can thus be achieved. The present invention likewise covers combinations of, or modifications of, the two variants mentioned of the sound-deadening elements.

Test Methods:

MVR Melt Index

MVR [230° C., 3.8 kg] is determined in accordance with ISO 1133.

Water Absorption (Boiling Test)

Water absorption is determined in a boiling test based on the EN 1087-1 standard. For this, a sample section of length 100 mm with production thickness and production width is immersed in boiling water for 5 h and after cooling for about 60 min in cold water is tested for swelling and gravimetric water absorption.

Breaking Strength and Deflection

Breaking strength and deflection at 500 N load are determined for the composite materials of the invention by a method based on DIN EN 310 (“wood-based panels; determination of modulus of elasticity in bending and of bending strength”).

The examples below serve for further explanation of the present invention and to improve understanding thereof, but in no way restrict the invention or its scope.

### COMPARATIVE EXAMPLE 1

A PMMA molding composition of moderate molecular weight, PLEXIGLAS® FM 6N or PLEXIGLAS® FM 7N from Evonik Rohm GmbH, Darmstadt, was mixed with a proportion of 70% by weight of wood fibers and extruded. Decomposition (carbonization) of the wood particles occurred, caused by high temperature (233° C. and above) and severe adhesion on the extrusion tooling. Only very inadequate plastification of the two components could be achieved.

### COMPARATIVE EXAMPLE 2

The extrusion process as in comparative example 1 was repeated with the use of the polar ester wax LICOWAX E from Clariant, Sulzbach as lubricant. It was thus possible to keep the temperature at about 200-205° C. during the production process and to inhibit metal adhesion. Decomposition of the wood particles was avoided.

However, the disadvantage of the resultant PMMA-wood composites was that water absorption in the boiling test at 100° C. was from 20 to 40% by weight. Swelling due to moisture was therefore unsatisfactory. All dimensions (length, width, thickness) of WPC products constituted as in comparative example 2 exhibited extreme deviations from the original dimension, and the products were therefore unsuitable for outdoor use.

### INVENTIVE EXAMPLE 1

General Description:

In accordance with the first preferred embodiment, styrene-maleic anhydride copolymer was added separately as adhesion promoter to the poly(alkyl) (meth)acrylate matrix material in the mixture in the formulation of comparative example 2.

Experiments showed that this type of mixture with up to 75% wood content can be plastified very successfully in the range 210° C.+/−10K, and provides WPC extrudates which have very low water absorption, high dimensional stability in the presence of moisture, and high mechanical stability.

### INVENTIVE EXAMPLE 1a

The experiment was carried out as in the general description. A styrene-maleic anhydride copolymer having about 20-22% by weight of incorporated maleic anhydride was used as adhesion promoter.

The amounts for the extrusion process were constituted as follows:

| | |
|---|---|
| Wood fibers: 320 μm | 70% |
| Adhesion promoter: XIRAN ® SZ 22065 | 6.0% |
| Lubricant: LICOWAX ® E | 3.0% |
| PMMA: PLEXIGLAS ® 7N | 21% |

The performance tests on the resultant WPC gave the following results:

| | |
|---|---|
| Water absorption in the boiling test at 100° C.: | 4.5% |
| Breaking strength: | 3.3 kN |
| Deflection, 500N: | 2.3 mm |

1. A composite material, comprising:
a cellulose-comprising material and a lubricant; and a plastic that comprises:
a) a poly(alkyl) (meth)acrylate matrix material having an MVR melt index [230° C., 3.8 kg] of from 0.5 to 30 mL/10 min; and
b) a cellulose-compatible adhesion promoter.

2. The composite material of claim 1, wherein the adhesion promoter comprises a copolymer comprising at least one monomer selected from the group consisting of a cyclic carboxylic anhydride derivative, a (meth)acrylic acid derivative, an aminomonomer, an imide monomer, and a monomer comprising an epoxy group.

3. The composite material of claim 2, wherein the adhesion promoter comprises a copolymer comprising the cyclic carboxylic anhydride derivative, which is a derivative comprising a 5-, 6-, or 7-membered ring.

4. The composite material of claim 1, wherein components a) and b) together form a copolymer comprising a poly(alkyl) (meth)acrylate and an adhesion-promoter monomer.

5. The composite material of claim 4, wherein the poly(alkyl) (meth)acrylate copolymerized with a cyclic carboxylic anhydride derivative comprises glutaric anhydride, a (meth)acrylic acid derivative, an aminomonomer, an imide monomer, and a monomer comprising an epoxy group, with styrene, an acrylate, a methacrylate, or any mixture thereof, as an adhesion-promoter monomer.

6. The composite material of claim 2, wherein the adhesion promoter copolymer has an MVR melt index [230° C., 3.8 kg] of from 1 to 30 mL/10 min.

7. The composite material of claim 1, wherein the proportion of the adhesion promoter, based on the total weight of the composite material of the invention, is from 0.5 to 70% by weight.

8. The composite material of claim 1, wherein the cellulose-comprising material comprises wood, paper, or paperboard.

9. The composite material of claim 8, comprising, based in each case on the total weight of the composite material, up to 80% by weight of wood particles, and at least 15% by weight of the poly(alkyl) (meth)acrylate.

10. The composite material of claim 1, wherein the lubricant comprises a a polyolefin, a polar ester wax, a polyethylene wax, a carboxylic acid, a fatty acid, or esters thereof, or
the lubricant comprises a long-chain fatty alcohol and a fatty alcohol ester.

11. The composite material of claim 1, comprising by weight percent:
a) from 1 to 59% of the poly(alkyl) (meth)acrylate matrix polymer;
b) from 1 to 50% of the adhesion promoter;
c) from 40 to 80% of the cellulose-comprising component;
d) from 0.1 to 5% of the lubricant;
e) from 0 to 5% of a colorant;
f) from 0 to 0.5% of a light stabilizer;
where components a) and b) together account for from 9.5% to 59.9% by weight of the total weight of components a) to f), and the entirety of components a) to f) is 100% by weight.

12. A process for producing the composite material of claim 1, the process comprising:
mixing the plastic cellulose-comprising component and a the lubricant to obtain a mixture, and
processing the mixture to obtain the composite material.

13. The process of claim 12, further comprising:
mixing the plastic with the cellulose-comprising component and the lubricant, a colorant, a light stabilizer, or both, to obtain the mixture.

14. The process of claim 12, wherein the processing comprises extruding or injecting molding the mixture.

15. A construction material comprising the composite material of claim 1.

16. The composite material of claim 1, wherein the poly(alkyl) (meth)acrylate matrix material has an MVR melt index [230° C., 3.8 kg] of from 1 to 20 mL/10 min.

17. The composite material of claim 1, wherein the poly(alkyl) (meth)acrylate matrix material has an MVR melt index [230° C., 3.8 kg] of from 1 to 10 mL/10 min.

18. The composite material of claim 2, wherein the copolymer of the adhesion promoter further comprises at least one monomer selected from the group consisting of styrene, an acrylate, a methacrylate, vinyl acetate, ethylene, and propylene.

19. The composite material of claim 8, wherein a proportion of cellulose in the wood, paper, or paperboard comprise is at least 20% by weight.
